(19) United States
(12) Patent Application Publication
(10) Pub. No.: US 2025/0368265 A1
(43) Pub. Date: Dec. 4, 2025

(54) VEHICLE BASE STRUCTURE

(71) Applicant: TOYOTA JIDOSHA KABUSHIKI KAISHA, Toyota-shi (JP)

(72) Inventor: Yuto NAKASHIMA, Nagakute-shi (JP)

(73) Assignee: TOYOTA JIDOSHA KABUSHIKI KAISHA, Toyota-shi (JP)

(21) Appl. No.: 19/188,375

(22) Filed: Apr. 24, 2025

(30) Foreign Application Priority Data
Jun. 4, 2024 (JP) 2024-090629

(51) Int. Cl. B62D 21/15; B60K 1/04

(52) U.S. Cl. CPC B62D 21/157; B60K 1/04; B60K 2001/0438

(57) ABSTRACT

In the vehicle base structure including side frames extending along the vehicle body front-rear direction on both sides in the vehicle width direction, a battery pack disposed between the side frames, and battery fastening members having boss portions fastened to the side frame and linking the side frame and the battery pack, the battery fastening member is provided with fragile portions at positions on the vehicle width direction inner side with respect to the position of the boss portion fastened to the side frame. Accordingly, when the vehicle broadside collision occurs, the portion on the outer side in the vehicle width direction and the side frame move toward the inner side in the vehicle width direction from the fragile portion in the battery fastening member due to the deformation of the fragile portion, thereby sufficiently securing the amount of compression deformation in the direction along the vehicle width direction.

### CROSS-REFERENCE TO RELATED APPLICATION

This application claims priority to Japanese Patent Application No. 2024-090629 filed on Jun. 4, 2024, incorporated herein by reference in its entirety.

### BACKGROUND

### 1. Technical Field

The present disclosure relates to a vehicle base structure. In particular, the present disclosure relates to an improvement for enhancing load absorbing performance in the event of a vehicle broadside collision.

### 2. Description of Related Art

Conventionally, there is a vehicle base structure for absorbing a side impact load (energy absorption) in the event of a vehicle broadside collision, disclosed in Japanese Unexamined Patent Application Publication No. 2017-196952 (JP 2017-196952 A). In the vehicle base structure disclosed in J P 2017-196952 A, a battery pack is disposed on a lower side of a floor panel, between a right and left pair of side sills (structural members) extending in a vehicle body front-rear direction. Recessed portions are formed in lower portions of the side sills. Reinforcing flange portions (reinforcing members), which are hollow, are disposed in the recessed portions. Also, upper face portions of the reinforcing flange portions are bolted to upper faces of the recessed portions, and faces of the reinforcing flange portions on inner sides in a vehicle width direction are welded to a case of the battery pack, whereby the side sills and the battery pack are linked by the reinforcing flange portions. Further, readily-deformable portions, which are formed by bending lower face portions of the reinforcing flange portions downward, are provided, and when a side impact load is input, the side impact load is absorbed by deforming the readily-deformable portions downward.

### SUMMARY

However, in the vehicle base structure disclosed in J P 2017-196952 A, the upper face portions of the reinforcing flange portions do not readily deform in the event of a vehicle broadside collision, due to the upper face portions being bolted to the recessed portions of the side sills. On the other hand, the lower face portions of the reinforcing flange portions are formed as readily-deformable portions, and accordingly the lower face portions are readily deformed in the event of a vehicle broadside collision. Thus, when the side impact load is input, there is a possibility that the reinforcing flange portions will pivot downward about axes extending in the vehicle body front-rear direction. When such pivoting of the reinforcing flange portions occurs, the side sills will also pivot downward. Even arrangements in which, for example, the side sills are subjected to compression deformation (deformation in a direction along the vehicle width direction) to absorb the load, cannot secure a sufficient amount of compression deformation thereof. There has been a limit in the level to which load absorption capabilities can be increased.

Even when the configuration disclosed in J P 2017-196952 A is applied to a vehicle in which energy absorbing members are disposed on outer sides of structural members (such as side frames) in the vehicle width direction, the energy absorbing members will also pivot along with the pivoting of the structural members. The amount of compression deformation of the energy absorbing members cannot be sufficiently secured. In this case as well, there is a limit in the level to which load absorption capabilities can be increased.

The present disclosure has been made in view of the above-described problems. It is an object thereof to provide a vehicle base structure that is capable of enhancing load absorbing performance, by securing a sufficient amount of compressive deformation of vehicle body components (in the above-described example, structural members or energy absorbing members) in the event of a vehicle broadside collision.

The solution of the present disclosure for achieving the above object assumes a vehicle base structure that includes
structural members that each extend along a vehicle body in a vehicle body front-rear direction, on both sides in a vehicle width direction,
a battery that is disposed between the structural members, and
battery fastening members that include fastening portions that are fastened to the structural members and that link the structural members and the battery.

Also, in this vehicle base structure,
the battery fastening members are provided with fragile portions at positions further on inner sides in the vehicle width direction than positions at which the fastening portions are fastened to the structural members, and
the vehicle base structure is configured such that in an event of a vehicle broadside collision,
the fragile portions are deformed such that portions of the battery fastening members further on outer sides of the fragile portions in the vehicle width direction and the structural members each move toward the inner sides in the vehicle width direction.

According to this specific matter, when the side impact load is input to the battery fastening members in the event of a vehicle broadside collision, the fragile portions that are provided in the battery fastening members are deformed by the side impact load. Thus, the portions of the battery fastening members on the outer sides of the fragile portions in the vehicle width direction, and the structural members, each move toward the inner sides in the vehicle width direction. When the portions further on the inner sides in the vehicle width direction than the positions of the fastening portions where the battery fastening members are fastened to the structural members are not readily deformed, there is concern that the battery fastening members and the structural members may pivot about the axes extending in the vehicle body front-rear direction. According to the present solution, the fragile portions are provided at positions further on the inner sides in the vehicle width direction than the positions of the fastening portions where the battery fastening members are fastened to the structural members. Due to the fragile portions deforming, the battery fastening members and the structural members move toward the inner sides in the vehicle width direction, while pivoting about the axes extending in the vehicle body front-rear direction is suppressed. Accordingly, a sufficient amount of compression deformation in the direction along the vehicle width direction is secured, and thus high load absorbing capabilities can be exhibited.

Also, another solution of the present disclosure for achieving the above object assumes a vehicle base structure that includes
structural members that each extend along a vehicle body in a vehicle body front-rear direction, on both sides in a vehicle width direction,
a battery that is disposed between the structural members, and
battery fastening members that include fastening portions that are fastened to the structural members and that link the structural members and the battery.

Also, in this vehicle base structure, the battery fastening members include upright wall portions that are situated between the battery and the structural members, and that extend in an up-down direction, and also include fragile portions in regions between the fastening portions and the upright wall portions.

According to this specific matter as well, when the side impact load is input to the battery fastening members, the fragile portions are deformed by the side impact load, such that the portions further on the outer sides in the vehicle width direction than the fragile portions in the battery fastening members, and the structural members, each move toward the inner sides in the vehicle width direction. That is to say, the structural members move toward the upright wall portions of the battery fastening members. When the structural members abut the upright wall portions of the battery fastening members, a great range of reaction force that is applied to the structural members by the battery fastening members with respect to the input of the side impact load is secured in the up-down direction of the vehicle body. Due to such movement being performed, the structural members that are fastened to the battery fastening members move toward the inner sides in the vehicle width direction, while pivoting about the axes extending in the vehicle body front-rear direction is suppressed. Accordingly, a sufficient amount of compression deformation in the direction along the vehicle width direction is secured, and thus high load absorbing capabilities can be exhibited.

Also, the fragile portions are situated on a lower side from the structural members.

According to this configuration, the distance between the structural members and the battery (distance in the vehicle width direction) can be shortened as compared with a configuration in which the fragile portions are provided at positions further on the inner sides in the vehicle width direction than the structural members. A situation in which the structural members readily pivot about the axes extending in the vehicle body front-rear direction in the event of a vehicle broadside collision, due to the long distance thereof, can be suppressed. That is to say, appropriately setting the positions of disposing the fragile portions can contribute to exhibiting high load absorbing capabilities, by securing a sufficient amount of compression deformation in the direction along the vehicle width direction.

Energy absorbing members that are compressively deformable when subjected to a side impact load are disposed on the outer sides of the structural members in the vehicle width direction. The energy absorbing members are disposed at positions overlapping at least part of each of the structural members and the fragile portions of the battery fastening members, as viewed from the vehicle width direction.

Accordingly, when the side impact load is input to the energy absorbing members in the event of a vehicle broadside collision, the side impact load is input to each of the fragile portions of the structural members and the battery fastening members via the energy absorbing members. That is to say, equivalent side impact loads are input to each of the structural members and the fragile portions of the battery fastening members. Accordingly, portions of the battery fastening members on the outer sides of the fragile portions in the vehicle width direction, and the structural members, can each be made to move toward the inner sides in the vehicle width direction in a sure manner, in conjunction with deformation of the fragile portions. Accordingly, the energy absorbing members can also be moved toward the inner sides in the vehicle width direction. As a result, the energy absorbing members move toward the inner sides in the vehicle width direction, while pivoting about the axes extending in the vehicle body front-rear direction is suppressed. A sufficient amount of compression deformation in the direction along the vehicle width direction is ensured. High load absorbing capabilities can be exhibited.

Further, a specific configuration of the fragile portions is a bent portion that protrudes either upward or downward in an up-down direction.

According to this, shapes of the fragile portions can be specifically identified for deforming the fragile portions so as to exhibit the above-described high load absorbing capabilities.

In the present disclosure, fragile portions are provided in battery fastening members that link structural members and a battery, and in the event of a vehicle broadside collision, deformation of these fragile portions causes portions of the battery fastening members further on outer sides from the fragile portions in a vehicle width direction, and the structural members, to each move toward inner sides in the vehicle width direction. Accordingly, a sufficient amount of compression deformation in a direction along the vehicle width direction is secured in the event of a vehicle broadside collision, and thus high load absorbing capabilities can be exhibited.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically illustrating a skeleton of a frame vehicle according to an embodiment;

FIG. 2 is a cross-sectional view taken along II-II line in FIG. 1;

FIG. 3 is a view corresponding to FIG. 2 illustrating an example of a state at a time point when a fragile portion is deformed at the time of a vehicle broadside collision;

FIG. 4 is a view corresponding to FIG. 2 illustrating an example of a state at a time point when the energy absorbing member is compressed and deformed at a time of a vehicle broadside collision;

FIG. 5A is a cross-sectional view illustrating a modification of a fragile portion;

FIG. 5B is a cross-sectional view showing a modification of the fragile portion; and

FIG. 5C is a cross-sectional view showing a modification of the fragile portion.

### DETAILED DESCRIPTION OF EMBODIMENTS

Hereinafter, an embodiment of the present disclosure will be described with reference to the drawings. The present embodiment describes a case where the present disclosure is applied to an electric frame vehicle (a vehicle having a so-called ladder frame) equipped with a driving battery.

### Structure of Frame Vehicle Frame

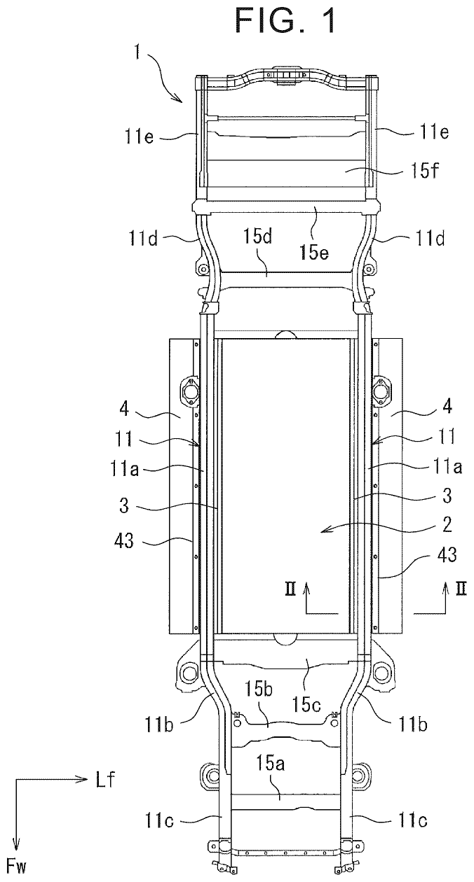

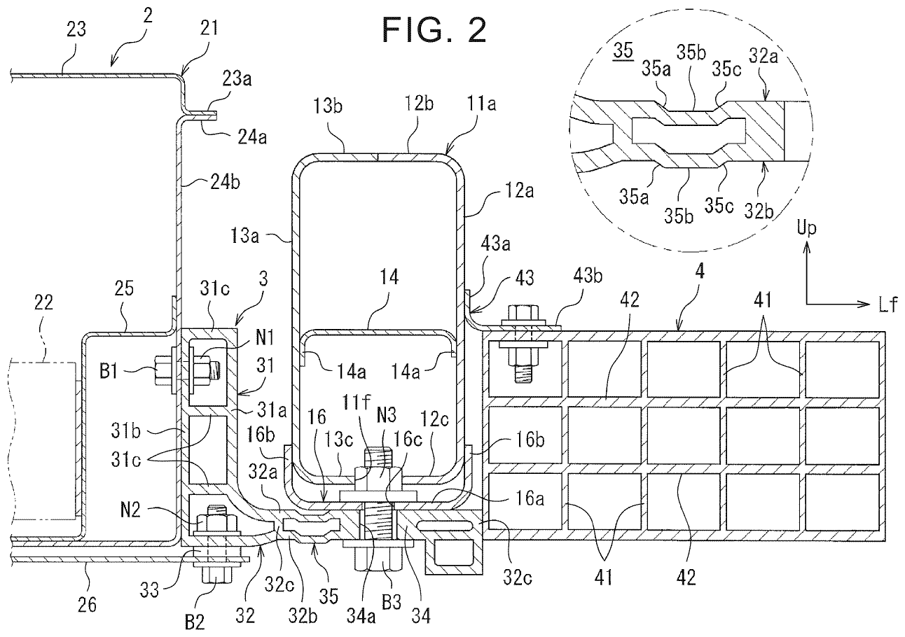

FIG. 1 is a plan view schematically showing a framework of a frame vehicle according to the present embodiment. FIG. 1 shows a state in which a battery pack (battery) 2 is mounted on a vehicle body frame 1 constituting a skeleton of a frame vehicle. Although FIG. 1 shows a configuration in which one large-sized battery pack 2 is mounted, a configuration in which a plurality of battery packs 2 are mounted may be employed. FIG. 2 is a cross-sectional view taken along II-II line in FIG. 1. Arrow Fw in these drawings indicates a vehicle body front direction, arrow Up indicates an upward direction, and arrow Lf indicates a left direction in the vehicle widthwise direction. Although FIG. 2 shows only the side frame (structural member) 11 on the left side in the vehicle width direction and the peripheral portion thereof, the side frame 11 on the right side in the vehicle width direction and the peripheral portion thereof have the same configuration (a configuration symmetrical to that of FIG. 2).

As shown in FIG. 1, the vehicle body frame 1 includes a pair of left and right side frames 11 and 11 extending along the vehicle body front-rear direction on both sides in the vehicle width direction. The side frames 11 and 11 have a closed cross-section, and include an intermediate portion 11a, 11a, a front kick portion 11b, 11b, a front portion 11c, 11c, a rear kick portion 11d, 11d, and a rear portion 11e, 11e.

The intermediate portions 11a extend in a horizontal direction along the vehicle body front-rear direction in a predetermined range between disposition positions of front wheels (not shown) and disposition positions of rear wheels (not shown). The front kick portion 11b is shaped so as to be continuous with the front end of the intermediate portion 11a and curved upward toward the front side of the vehicle body. Each of the front portions 11c is continuous with a front end of each of the front kick portions 11b and extends toward the front side of the vehicle body. The rear kick portion 11d is shaped to continue to the rear end of the intermediate portion 11a and to curve upward toward the rear side of the vehicle body. Each of the rear portions 11e is continuous with a rear end of each of the rear kick portions 11d and extends toward the rear side of the vehicle body.

As a specific configuration of the side frame 11, the outer structural member 12, the inner structural member 13, and the reinforcing structural member 14 are integrally joined to each other so as to show a cross section (a cross section in the intermediate portion 11a) in FIG. 2. The outer structural member 12 and the inner structural member 13 each include a vertical portion 12a, 13a extending in the vertical direction, an upper plate portion 12b, 13b extending in the horizontal direction from an upper end of the vertical portion 12a, 13a, and a lower plate portion 12c, 13c extending in the horizontal direction from a lower end of the vertical portion 12a, 13a. The upper plate portion 12b, 13b and the lower plate portion 12c, 13c are butt-welded to each other to form a closed cross section. FIG. 2 is a cross section at a part other than the butt-welded part of the lower plate portion 12c, 13c. The reinforcing structural member 14 is disposed so as to extend in the horizontal direction inside the closed cross-sectional structure of the side frame 11. The respective flanged portions 14a, 14a are welded to the inner side surfaces of the respective structural members 12 and 13 on the vertical portion 12a, 13a. This increases the rigidity of the entire side frame 11. The side frame 11 is not limited to the above-described configuration.

As shown in FIG. 1, a plurality of cross-member 15a-15f extending along the vehicle width direction are bridged between the side frames 11 and 11.

Battery-pack 2 for storing electric power to be supplied to an electric motor (not shown), which is a driving force source of the vehicles, is disposed between the intermediate portion 11a, 11a of the side frames 11 and 11.

FIG. 2 shows a part of the battery pack 2 (an outer side part in the vehicle width direction). As shown in FIG. 2, the battery pack 2 has a configuration in which a battery module 22 (indicated by a two-dot chain line in FIG. 2) is accommodated in a battery case 21. The battery case 21 includes a case upper 23, a case lower 24, and a case inner 25. By joining the flange portions 23a, 24a provided at the outer edge portions of the case upper 23 and the case lower 24, respectively, the housing space of the battery module 22 is formed by the case upper 23 and the case lower 24. The case inner 25 is welded to the case lower 24 at a plurality of positions, and supports the battery module 22. Further, the battery pack 2 is provided with a base plate 26 to be fastened to a battery fastening member 3 described later. The fastening structure of the battery fastening member 3 and the base plate 26 will be described later. The battery pack 2 is not limited to the above-described configuration.

The battery pack 2 is supported by the side frame 11 by the battery fastening member 3. That is, the battery fastening member 3 is fastened to each of the battery pack 2 and the side frame 11, thereby linking the battery pack 2 and the side frame 11. Hereinafter, the battery fastening member 3 will be described.

The battery fastening member 3 is made of metal and includes an upright wall portion 31 extending along the up-down direction, and a horizontal portion 32 extending toward the outer side in the vehicle width direction continuously from the lower end of the upright wall portion 31. The battery fastening member 3 is disposed on the vehicle width direction outer side in the intermediate portion 11a, 11a of the side frames 11 and 11.

The upright wall portion 31 is positioned between the battery pack 2 and the side frame 11, and includes an outer plate portion 31a and an inner plate portion 31b which are disposed at positions perpendicular to the vehicle width direction and spaced apart from each other in the vehicle width direction. The outer plate portion 31a and the inner plate portion 31b are linked by a plurality of horizontally extending linking plate portion 31c, 31c, . . . . As a result, the upright wall portion 31 is formed of a member having a closed cross-sectional structure having a space at a plurality of positions inside, and is reduced in weight while ensuring high rigidity. The inner-plate portion 31b is superposed on the outer surface of the case lower 24 on the upright wall portion 24b. Bolt insertion holes (not shown in the drawings) are provided in the inner plate portion 31b of the battery fastening member 3 and the upright wall portion 24b of the case lower 24, respectively. A nut N1 is welded to a bolt insertion hole provided in the inner plate portion 31b of the battery fastening member 3. Then, with the bolt insertion holes aligned, the bolt B1 are inserted into the bolt insertion holes, and the case lower 24 and the upright wall portion 31 are integrally fastened by screwing the bolt B1 into the nut N1. Although not shown, the battery case 21 is provided with an opening or the like for inserting a tool for performing the bolt fastening operation. Incidentally, the configuration for fastening the case lower 24 and the upright wall portion 31 is not limited to this, the outer surface of the upright wall portion 24b of the case lower 24 and the upper surface of the upright wall portion 31 may be linked via brackets.

The horizontal portion 32 includes an upper plate portion 32a and a lower plate portion 32b that extend along the horizontal direction (vehicle width direction) and are disposed at positions spaced apart from each other in the up-down direction. The vehicle width direction inner portion of the upper plate portion 32a is contiguous with the lower end portion of the outer plate portion 31a of the upright wall portion 31. The vehicle width direction inner part of the lower plate portion 32b is continuous with the lower end part of the inner plate portion 31b of the upright wall portion 31. The upper plate portion 32a and the lower plate portion 32b are linked by a plurality of linking plate portions 32c, 32c extending in the up-down direction. As a result, the horizontal portion 32 is also formed of a member having a closed cross-sectional structure having a space at a plurality of positions inside, and thus weight reduction is achieved while securing high rigidity. The lower plate portion 32b is located above the vehicle width direction outer portion of the base plate 26 of the battery pack 2. Bolt insertion holes (not shown in the drawings) are provided in each of the lower plate portion 32b and the base plate 26. A nut N2 is welded to a bolt insertion hole provided in the lower plate portion 32b. Then, with the bolt insertion holes aligned, the bolt B2 are inserted into the bolt insertion holes, and the bolt B2 is screwed into the nut N2, whereby the base plate 26 and the horizontal portion 32 are integrally fastened. A spacer 33 is interposed between the lower plate portion 32b and the base plate 26 as needed. The fastening structure of the battery fastening member 3 and the battery case 21 is not limited to the above-described configuration.

Further, the center portion of the horizontal portion 32 in the vehicle width direction is integrally fastened to the lower portion of the side frame 11. Hereinafter, the fastening structure will be described.

The horizontal portion 32 is provided with a boss portion (fastening portion) 34 having a bolt insertion hole 34a extending in the up-down direction therethrough. The boss portion 34 is disposed from the upper plate portion 32a to the lower plate portion 32b of the horizontal portion 32, and is formed in, for example, a cylindrical shape. Further, the boss portion 34 may have a rectangular cylindrical shape. On the other hand, a supplementary plate 16 is joined to the lower side of the side frame 11. The supplementary plate 16 includes a horizontal portion 16a and a flanged portion 16b, 16b extending upward from both sides of the horizontal portion 16a in the vehicle width direction. The flanged portions 16b, 16b are welded to the outer surfaces of the structural members 12 and 13 on the vertical portion 12a, 13a. A bolt-insertion hole 16c is provided in a central portion of the supplementary plate 16 on 16a of the horizontal portion. In addition, a nut-insertion hole 11f is provided in a central portion of a lower portion of the side frame 11. The nut-insertion hole 11f is formed at a position opposite to the bolt-insertion hole 16c of the supplementary plate 16. The nut N3 is welded to the bolt insertion hole 16c of the supplementary plate 16. A part of the nut N3 is also inserted into the nut insertion hole 11f of the side frame 11. With the bolt insertion holes 34a, 16c aligned, the bolt B3 is inserted into the bolt insertion holes 34a, 16c. The bolt B3 is screwed into the nut N3. As a result, the center portion of the horizontal portion 32 in the vehicle width direction is integrally fastened to the lower portion of the side frame 11. The configuration in which the horizontal portion 32 is fastened to the side frame 11 is not limited to the configuration described above.

An energy absorbing member 4 is disposed outside the side frame 11 in the vehicle width direction. The energy absorbing member 4 is a member that receives a side impact load when a vehicle broadside collision occurs, and compresses and deforms to absorb the side impact load (energy absorption). The energy absorbing member 4 includes a plurality of vertical plate portions 41, 41, . . . , which are disposed at predetermined intervals in the vehicle width direction, and a plurality of horizontal plate portions 42, 42, . . . , which are disposed at predetermined intervals in the up-down direction. Further, as shown in FIG. 1, the energy absorbing member 4 is disposed on the outer side of the intermediate portion 11a, 11a of the side frames 11 and 11.

The vertical portion 12a of the outer structural member 12 in the side frame 11 and the upper surface of the energy absorbing member 4 are linked by L-shaped linking brackets 43. Specifically, the vertical portion 43a of the linking bracket 43 is welded to the outer surface of the vertical portion 12a of the outer structural member 12, and the horizontal portion 43b of the linking bracket 43 is bolted to the upper surface of the energy absorbing member 4.

In this way, the energy absorbing member 4 is disposed on the vehicle width direction outer side of the side frame 11. In this state, the energy absorbing member 4 is disposed at a position overlapping the lower portion of the side frame 11 and the battery fastening member 3, respectively, when viewed from the vehicle width direction. That is, when a side impact load is input to the energy absorbing member 4, the side impact load is input to each of the side frame 11 and the battery fastening member 3 (in particular, the horizontal portion 32) via the energy absorbing member 4 (input toward the vehicle width direction inner side). That is, the same side impact load is input to each of the side frame 11 and the battery fastening member 3.

As a feature of the present embodiment, the horizontal portion 32 of the battery fastening member 3 is provided with a fragile portion 35. The position at which the fragile portion 35 is disposed is a position on the inner side in the vehicle width direction than the position at which the battery fastening member 3 is fastened to the side frame 11 (the position of the boss portion 34), and is a position on the lower side of the side frame 11. This is a position overlapping with the side frame 11 in the up-down direction.

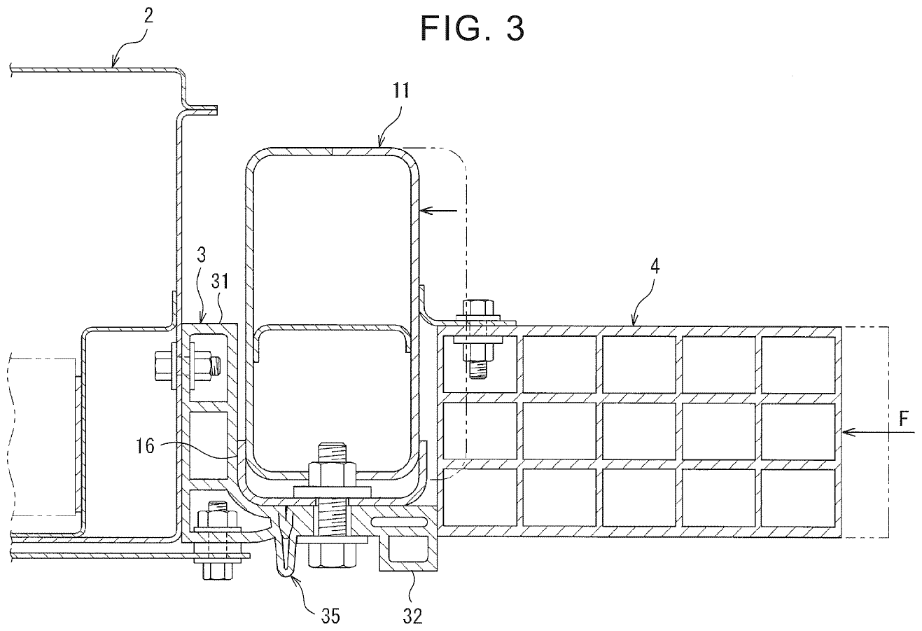

As a specific configuration of the fragile portion 35, both the upper plate portion 32a and the lower plate portion 32b have a cross-sectional shape slightly bent downward (a cross-sectional shape protruding downward). That is, the fragile portion 35 includes the first inclined portion 35a, 35a, the horizon portion 35b, 35b, and the second inclined portion 35c, 35c, as illustrated in FIG. 1 surrounded by a circle with a chain line. The first inclined portion 35a, 35a is inclined downward toward the vehicle width direction outer side. The horizontal portion 35b, 35b extends in the horizontal direction from the vehicle width direction outer portion of the first inclined portion 35a, 35a toward the vehicle width direction outer side. The second inclined portion 35c, 35c is inclined upward from the vehicle width direction outer portion of the horizontal portion 35b, 35b toward the vehicle width direction outer side. The fragile portion 35 is provided over the entire horizontal portion 32 of the battery fastening member 3 in the vehicle body front-rear direction. The configuration of the fragile portion 35 is not limited to this, and may be a cross-sectional shape curved downward. In addition, the cross-sectional shape may be a cross-sectional shape bent upward or a cross-sectional shape curved upward. By providing such a fragile portion 35, when a horizontal load (side impact load) is inputted to the horizontal portion 32 of the battery fastening member 3, the fragile portion 35 (the bent portions of the upper plate portion 32a and the lower plate portion 32b respectively) is deformed so as to bend downward (see the state of FIG. 3). The vehicle width direction outer portion of the horizontal portion 32 of the battery fastening member 3 moves in the substantially horizontal direction toward the vehicle width direction inner side than the fragile portion 35.

### Vehicle Broadside Collision

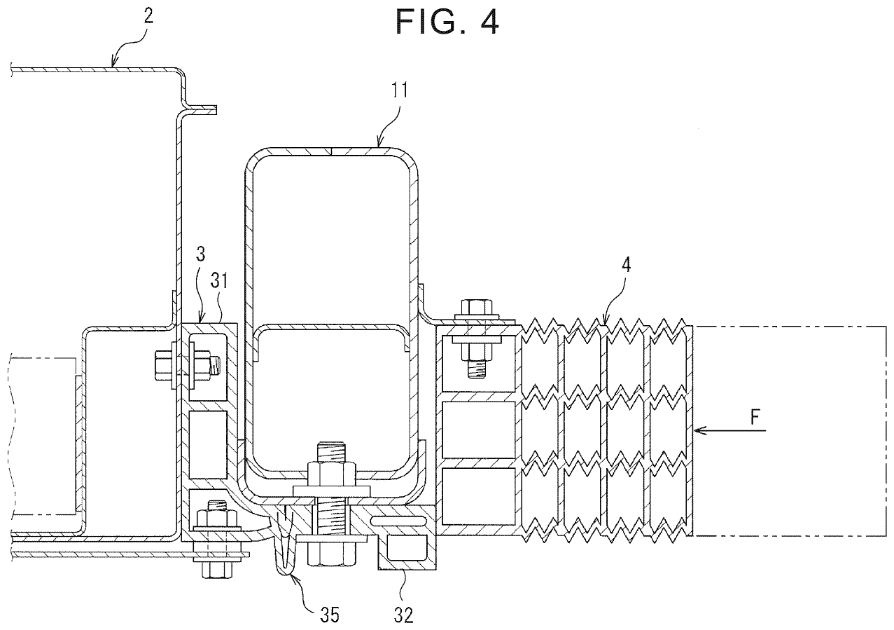

Next, a deformation state at the time of a vehicle broadside collision in the vehicle base structure configured as described above will be described. FIG. 3 is a view corresponding to FIG. 2 illustrating an example of a state at a time point when the fragile portion 35 is deformed at the time of a vehicle broadside collision. FIG. 4 is a diagram corresponding to FIG. 2 illustrating an example of a state at a time point when the energy absorbing member 4 is compressively deformed at a vehicle broadside collision. In the state of FIG. 3, although the fragile portion 35 is deformed by the side impact load, the energy absorbing member 4 is not yet deformed, the energy absorbing member 4 may also start deformation with the start of deformation of the fragile portion 35.

When the side impact load F is input to the horizontal portion 32 of the battery fastening member 3 via the energy absorbing member 4 at the time of the vehicle broadside collision, the fragile portion 35 provided in the horizontal portion 32 is deformed so as to be bent downward by the side impact load F. As described above, the side impact load is input to each of the fragile portions 35 of the side frame 11 and the battery fastening member 3 via the energy absorbing member 4. Therefore, the same side impact load is input to each of the fragile portions 35 of the side frame 11 and the battery fastening member 3. As a result, the vehicle width direction outer portion of the horizontal portion 32 of the battery fastening member 3 moves in the substantially horizontal direction toward the vehicle width direction inner side than the fragile portion 35. The side frame 11 is fastened to an outer portion of the horizontal portion 32 of the battery fastening member 3 in the vehicle width direction rather than the fragile portion 35. Therefore, the side frame 11 also moves in the substantially horizontal direction toward the inside in the vehicle width direction. Further, since the energy absorbing member 4 is linked to the vehicle width direction outer portion of the side frame 11, the energy absorbing member 4 also moves in the substantially horizontal direction toward the vehicle width direction inner side.

As described above, the deformation of the fragile portion 35 causes the side frame 11 and the energy absorbing member 4 to both move in the substantially horizontal direction toward the inside in the vehicle width direction. That is, the side frame 11 and the energy absorbing member 4 move in a state in which rotation around an axis extending in the vehicle body front-rear direction is suppressed. In the prior art, in a case where the portion on the inner side in the vehicle width direction is less likely to be deformed than the position of the fastening portion (boss portion 34 in the case of the present embodiment) with respect to the side frame in the battery fastening member, the battery fastening member and the side frame may be rotated about an axis extending in the vehicle body front-rear direction. In the present embodiment, the fragile portion 35 is provided at a position on the inner side in the vehicle width direction than the position of the boss portion 34, which is a fastening portion of the battery fastening member 3 to the side frame 11. As the fragile portion 35 is deformed, the battery fastening member 3 and the side frame 11 move toward the inside in the vehicle width direction while being suppressed from rotating about an axis extending in the vehicle body front-rear direction.

When the side impact load F is further input from the state shown in FIG. 3, as shown in FIG. 4, the energy absorbing member 4 compresses and deforms along the vehicle width direction to absorb the side impact load (energy absorption). As described above, the energy absorbing member 4 is compressed and deformed in a state in which the energy absorbing member is prevented from rotating about an axis extending in the vehicle body front-rear direction. A sufficient amount of compression deformation in the direction along the vehicle width direction is ensured. High load absorbing performance is achieved. Even if the side frame 11 is deformed by the side impact load F, the side frame 11 is compressed and deformed in a state in which the side frame is prevented from rotating about an axis extending in the vehicle body front-rear direction. As a result, high load absorbing performance is also exhibited.

### Effects of Embodiment

As described above, in the present embodiment, the fragile portion 35 is provided in the battery fastening member 3 linking the side frame 11 and the battery pack 2. At the time of vehicle broadside collision, the deformation of the fragile portion 35, the vehicle width direction outer portion than the fragile portion 35 in the battery fastening member 3 (boss portion 34 and its peripheral portion), the side frame 11 and the energy absorbing member 4, respectively, is moved toward the vehicle width direction inner. Accordingly, a sufficient amount of compression deformation in a direction along the vehicle width direction is secured in the event of a vehicle broadside collision, and thus high load absorbing capabilities can be exhibited.

In the present embodiment, the fragile portion 35 of the battery fastening member 3 is positioned below the side frame 11. Therefore, compared with a configuration in which the fragile portion 35 is provided at a position on the inner side in the vehicle width direction than the side frame 11, the interval (the interval in the vehicle width direction) between the side frame 11 and the battery pack 2 can be shortened. It is possible to suppress a situation in which the side frame 11 is easily rotated about an axis extending in the vehicle body front-rear direction due to the long interval. For example, in the configuration disclosed in Japanese Unexamined Patent Application Publication No. 2014-80116 (JP 2014-80116 A), the space between the side frame and the battery pack is long. Therefore, the side frame is easily rotated around an axis extending in the vehicle body front-rear direction in the vehicle broadside collision. In the present embodiment, the distance between the side frame 11 and the battery pack 2 can be shortened. It is possible to prevent the side frame 11 from being easily rotated about an axis extending in the vehicle body front-rear direction. The present embodiment can contribute to achieving high load absorbing performance by sufficiently securing the amount of compressive deformation in a direction along the vehicle width direction.

### Modifications

Next, a modification will be described. This modification is different from the embodiment described above in the configuration of the fragile portion 35. Since the other configuration and the operation at the time of the vehicle broadside collision (the movement of the side frame 11 and the energy absorbing member 4, etc.) are the same as those of the above-described embodiment, only the configuration of the fragile portion 35 will be described here.

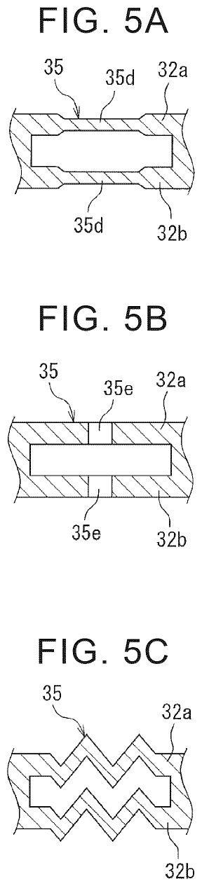

FIGS. 5A to 5C are cross-sectional views illustrating a plurality of modifications of the fragile portion 35. In FIGS. 5A to 5C, only the fragile portion 35 and the peripheral portion thereof in the battery fastening member 3 are shown in an enlarged manner.

In FIG. 5A, the fragile portion 35 is formed by providing thin-walled portions 35d, 35d at a portion of each of the upper plate portion 32a and the lower plate portion 32b of the horizontal portion 32 of the battery fastening member 3. The cross-sectional shapes of the thin-walled portions 35d, 35d coincide with each other, and the deformation amounts (the deformation amounts in the direction along the vehicle width direction) of the upper plate portion 32a and the lower plate portion 32b when the side impact load is inputted substantially coincide with each other.

As shown in FIG. 5B, the fragile portion 35 is formed by providing an opening 35e, 35e that penetrates in the up-down direction in a part of each of the upper plate portion 32a and the lower plate portion 32b of the horizontal portion 32 of the battery fastening member 3. The opening areas of the respective opening 35e, 35e are matched, and the deformation amounts (the deformation amounts along the vehicle width direction) of the upper plate portion 32a and the lower plate portion 32b when the side impact load is inputted substantially coincide with each other.

In FIG. 5C, the fragile portion 35 is formed by forming a part of each of the upper plate portion 32a and the lower plate portion 32b of the horizontal portion 32 of the battery fastening member 3 into a bellows shape. The bellows shapes substantially coincide with each other, and the deformation amounts (the deformation amounts in the direction along the vehicle width direction) of the upper plate portion 32a and the lower plate portion 32b when the side impact load is inputted substantially coincide with each other.

It should be noted that the configuration of the fragile portion 35 in the above-described embodiments and modifications can be combined with each other. For example, the structure of the fragile portion 35 of the above-described embodiment may be thinned as shown in FIG. 5A, or the structure of the fragile portion 35 of the above-described embodiment may be provided with an opening 35e as shown in FIG. 5B.

According to these modification examples, as in the case of the above-described embodiment, the fragile portion 35 is deformed at the time of the vehicle broadside collision, so that the compression deformation amount in the direction along the vehicle width direction is sufficiently secured, and thus high load absorbing performance can be exhibited.

### OTHER EMBODIMENTS

It should be noted that the present disclosure is not limited to the above-described embodiment and the above-described modification examples, and all modifications and applications encompassed within the scope of the claims and the scope of equivalents thereof are possible.

For example, in the above-described embodiment and the above-described modification, a case where the present disclosure is applied to a frame vehicle has been described. The present disclosure is not limited to this, and may be applied to a monocoque vehicle. In this case, the member corresponding to the side frame (structural member) 11 is a rocker. An energy absorbing member is not disposed on the vehicle width direction outer side of the rocker. Therefore, the side impact load is directly input to the rocker when the vehicle broadside collision occurs. Even in this case, at the time of the vehicle broadside collision, the rocker moves in the substantially horizontal direction toward the inner side in the vehicle width direction, and is compressed and deformed in a state in which the rocker is prevented from rotating about an axis extending in the vehicle body front-rear direction. A sufficient amount of compression deformation is ensured. High load absorbing performance is achieved. Further, in the case of a configuration in which the energy absorbing member is accommodated in the rocker, the amount of compressive deformation of the energy absorbing member is sufficiently secured, and thus the high load absorbing performance is also exhibited.

In the above-described embodiment, the fragile portion 35 is provided over the entire horizontal portion 32 of the battery fastening member 3 in the vehicle body front-rear direction. The present disclosure is not limited to this, and the fragile portion 35 may be provided intermittently (at a predetermined interval) in the vehicle body front-rear direction in the horizontal portion 32 of the battery fastening member 3. In this case, since it is preferable that the input position of the side impact load and the arrangement position of the fragile portion 35 at the time of the vehicle broadside collision face each other in the vehicle width direction, it is preferable that the distance in the vehicle body front-rear direction in which the fragile portion 35 is disposed is shorter.

Further, in the above-described embodiment and the above-described modification, the area where the battery pack 2 and the battery fastening member 3 are disposed is a position corresponding to the intermediate portion 11a, 11a of the side frames 11 and 11. That is, the battery pack 2 is disposed on the vehicle width direction inner side corresponding to the intermediate portion 11a, 11a, and the battery fastening member 3 is disposed on the vehicle width direction outer side corresponding to the intermediate portion 11a, 11a. The present disclosure is not limited to this, and the battery pack 2 and the battery fastening member 3 may be disposed so as to correspond to other portions of the side frames 11 and 11.

The present disclosure can be applied as a vehicle base structure for enhancing absorption performance of side impact load in vehicle broadside collision.

What is claimed is:

1. A vehicle base structure, comprising:
structural members that each extend along a vehicle body in a vehicle body front-rear direction, on both sides in a vehicle width direction;
a battery that is disposed between the structural members; and
battery fastening members that include fastening portions that are fastened to the structural members and that link the structural members and the battery, wherein
the battery fastening members are provided with fragile portions at positions further on inner sides in the vehicle width direction than positions at which the fastening portions are fastened to the structural members, and
the vehicle base structure is configured such that in an event of a vehicle broadside collision, the fragile portions are deformed such that portions of the battery fastening members further on outer sides of the fragile portions in the vehicle width direction and the structural members each move toward the inner sides in the vehicle width direction.

2. A vehicle base structure, comprising:
structural members that each extend along a vehicle body in a vehicle body front-rear direction, on both sides in a vehicle width direction;
a battery that is disposed between the structural members; and
a battery fastening member that includes a fastening portion that is fastened to the structural members and that links the structural members and the battery, wherein
the battery fastening members include upright wall portions that are situated between the battery and the structural members, and that extend in an up-down direction, and also include fragile portions in regions between the fastening portions and the upright wall portions.

3. The vehicle base structure according to claim 1, wherein the fragile portions are situated on a lower side from the structural members.

4. The vehicle base structure according to claim 2, wherein the fragile portions are situated on a lower side from the structural members.

5. The vehicle base structure according to claim 1, wherein:
energy absorbing members that are compressively deformable when subjected to a side impact load are disposed on the outer sides of the structural members in the vehicle width direction; and
the energy absorbing members are disposed at positions overlapping at least part of each of the structural members and the fragile portions of the battery fastening members, as viewed from the vehicle width direction.

6. The vehicle base structure according to claim 2, wherein:
energy absorbing members that are compressively deformable when subjected to a side impact load are disposed on the outer sides of the structural members in the vehicle width direction; and
the energy absorbing members are disposed at positions overlapping at least part of each of the structural members and the fragile portions of the battery fastening members, as viewed from the vehicle width direction.

7. The vehicle base structure according to claim 1, wherein the fragile portions are a bent portion that protrudes either upward or downward in an up-down direction.

8. The vehicle base structure according to claim 2, wherein the fragile portions are a bent portion that protrudes either upward or downward in an up-down direction.
